(19) United States
(12) Patent Application Publication
(10) Pub. No.: US 2025/0283750 A1
(43) Pub. Date: Sep. 11, 2025

(54) SYSTEM FOR DETECTING A FILL LEVEL

(71) Applicant: emz-Hanauer GmbH & Co. KGaA, Nabburg (DE)

(72) Inventor: LUKAS SCHADE, Nabburg (DE)

(21) Appl. No.: 19/041,220

(22) Filed: Jan. 30, 2025

(30) Foreign Application Priority Data
Mar. 5, 2024 (DE) 102024106312.2

(51) Int. Cl. G01F 23/292

(52) U.S. Cl. CPC G01F 23/2921

(57) ABSTRACT

A system for detecting a liquid level for a household appliance includes a container for holding the liquid. At least one radiation source device and at least one detection device are provided. The container consists at least partially of a material which is at least partially transparent for the emitted radiation of the at least one radiation source device. In a first state the emitted radiation of the at least one radiation source device has a defined beam path through the container. A change in radiation properties of the emitted radiation can be detected by means of the at least one detection device.

### CROSS-REFERENCE TO RELATED APPLICATIONS

This application claims priority to German Patent Application 102024106312.2, filed on Mar. 5, 2024, the contents of which is incorporated by reference herein.

### TECHNICAL FIELD

The invention relates to a system for detecting a liquid level for a household appliance comprising a container for holding the liquid.

### BACKGROUND

In household appliances, especially in water-bearing household appliances such as washing machines or dishwashers, it is often necessary to monitor the liquid level in certain containers. This is necessary in automatic dosing systems, for example. Such automatic dosing systems comprise a container in which a liquid in the form of a treatment agent, for example a detergent, rinsing agent or similar, is stored. If the level falls below a minimum level, a corresponding fill-up is necessary.

It may also be necessary to monitor the fill level of household appliances that do not use water. Such household appliances can include collection containers for liquids, for example condensation liquids. When a maximum level is reached, this collection container must be emptied. In both of these cases, it is desirable to monitor the fill level either to alert the user or to initiate an automatic process.

### SUMMARY

The task of the present invention is to provide a system for detecting a liquid level for a household appliance which is as simple and inexpensive as possible to manufacture.

According to the invention, a system for detecting a liquid level for a household appliance is provided, comprising a container for holding the liquid, wherein at least one radiation source device and at least one detection device are provided, wherein the container consists at least partially of a material which is at least partially transparent for the emitted radiation of the at least one radiation source device, wherein in a first state the emitted radiation of the at least one radiation source device has at least one defined beam path through the container, which is at least partially transparent for the emitted radiation of the at least one radiation source device, wherein in a first state the emitted radiation of the at least one radiation source device has at least one defined beam path through the container, wherein a change in radiation properties of the emitted radiation can be detected by means of the at least one detection device.

According to the invention, the radiation properties of the emitted radiation are thus evaluated. The emitted radiation initially has a defined beam path through the container. Preferably, this fixed beam path corresponds to the fill level to be detected. If the fill level changes, the position of the beam entry at the container does not change. However, the radiation properties change due to a change in the medium through which the radiation passes when the fill level changes. The system according to the invention thus represents a particularly simple and cost-effective way of detecting a fill level in a container.

The container advantageously has an extension along a height axis (Z), a width axis (X) and a longitudinal axis (Y). Preferably, the container is hollow cylindrical with a geometric base surface of any shape. The base surface can, for example, be circular, elliptical, square, rectangular, triangular or any other polygon.

The container comprises a conversion which at least partially encloses an interior space. This interior space is preferably filled with a first medium and a second medium. Preferably, the wall is at least partially transparent to the emitted radiation. Preferably, the wall has a constant wall thickness. However, embodiments with a non-constant wall thickness would also be conceivable. Preferably, the first medium and the second medium are at least partially transparent to the emitted radiation. “At least partially transparent” means that the emitted radiation can pass through the wall or the medium without being completely absorbed.

The liquid level can be defined as a height along the height axis (Z) at which the liquid surface is located. At a predetermined minimum level, there is advantageously a predetermined minimum amount of liquid in the container. The liquid surface is thus at a minimum height along the height axis (Z). At a predetermined maximum level, there is advantageously a predetermined maximum amount of liquid in the container. The liquid surface is thus at a maximum height along the height axis (Z).

According to a particularly preferred embodiment, in a first state the emitted radiation passes through a first medium in the container. Preferably, in a second state, the emitted radiation passes through a second medium in the container. Advantageously, the emitted radiation of the at least one radiation source device first enters the wall of the container. Subsequently, the emitted radiation advantageously passes through the first medium or the second medium. Finally, the emitted radiation exits the container again through the wall of the container.

Preferably, this emitted radiation can hit the at least one detection device. It is also conceivable that the emitted radiation only strikes the at least one detection device in one of the two states and does not strike the at least one detection device in the other state.

Preferably, at least a partial amount of the first medium is removed from the container during a transition from the first state to the second state and replaced by the second medium. Preferably, a transition from the first state to the second state is effected by a change in the liquid level in the container. Preferably, the first medium is the liquid or a gas mixture, for example air. Preferably, the second medium is a gas mixture, for example air or the liquid.

According to a preferred embodiment, the first medium is the liquid and the second medium is the gas mixture, for example air. When liquid is removed from the container, the removed volume of liquid is replaced by the gas mixture or air. Advantageously, the beam path of the emitted radiation is defined in such a way that it passes through the container at a first height along the height axis (Z). The first height is advantageously close to the height of the minimum level or at the height of the minimum level. Preferably, the emitted radiation passes through liquid in the first state and through a gas mixture or air in the second state. By changing the type of medium passing through, the radiation undergoes a change in the radiation properties, which can be detected by the at least one detection device. It is therefore advantageous to be able to detect a drop below the minimum level.

According to another preferred embodiment, the first medium is the gas mixture, for example air, and the second medium is the liquid. When liquid is fed into the container, the gas mixture or air is displaced from the container. Advantageously, the beam path of the emitted radiation is defined in such a way that it passes through the container at a second height along the height axis (Z). The second height is advantageously close to the height of a maximum level or at the height of the maximum level. Preferably, the emitted radiation therefore passes through a gas mixture or air in the first state and through the liquid in the second state. Due to the change in the type of medium passing through, the radiation undergoes a change in the radiation properties, which can be detected by the at least one detection device. Exceeding the maximum level can thus be advantageously detected.

Preferably, in a first state, the emitted radiation of the at least one radiation source device only has a fixed beam path through the container.

According to a further preferred embodiment, in a first state, the emitted radiation of the at least one radiation source device has a plurality of defined beam paths through the container.

Preferably, the system thus comprises several detection planes, with a beam path being assigned to each detection plane. Furthermore, a minimum level or a maximum level is assigned to each detection plane. Advantageously, the detection planes are arranged one above the other along the height axis Z of the container. It is therefore advantageous that the minimum level or maximum level can be detected in each detection plane. From this, different fill levels can be output with knowledge of the height of the respective detection plane. Preferably, a reference plane is provided in which a beam path is always located in the first medium or the second medium. The detection of this radiation can therefore be used as a reference, for example to compensate for temperature fluctuations.

Preferably, several radiation source devices are provided, which generate radiation with the several defined beam paths. It is also conceivable that only one radiation source device is provided, whereby the radiation with the several defined beam paths is generated by means of optical components, for example beam splitters.

Advantageously, the change in radiation properties is due to a difference in optical properties between the first medium and the second medium. Preferably, the optical properties comprise at least one refraction angle and/or the radiation intensity of the radiation. Preferably, during a transition from the first state to the second state, at least one refraction angle and/or the radiation intensity of the emitted radiation changes. Advantageously, the complex-value refractive index can be identified as an optical property:

$$\overline{n} ( λ ) = n ( λ ) + i κ ( λ )$$

Here, “n” corresponds to the real refractive index, which indicates the ratio of the vacuum light speed to the propagation speed of the light in the medium. “κ” describes the absorption of the radiation in the medium. Light is refracted and reflected at the interface of two media with different refractive indices. At such a transition at an interface into a different medium, Snellius' law of refraction describes the change in direction of the propagation direction of the radiation:

n₁ sin θ₁=n₂ sin θ₂

Where n₁ and n₂ are the refractive indices of the respective media. Θ₁ is the angle of incidence of the radiation and θ₂ is the angle of refraction of the radiation

Advantageously, the emitted radiation passes through at least one interface between two media. Preferably, the emitted radiation passes through a plurality of interfaces. In the present case, there are at least the interfaces between the ambient air and the wall of the container, between the wall of the container and a medium inside the container (liquid or gas mixture or air), between a medium inside the container (liquid or gas mixture or air) and the wall of the container and between the wall of the container and the ambient air.

Advantageously, the emitted radiation is not incident perpendicular to at least one interface. Accordingly, at least one angle of incidence (θ₁) of the emitted radiation with respect to an interface is preferably not equal to 90°. Preferably, there is no perpendicular incidence of the emitted radiation on the container. The angle of incidence (θ₁) with respect to the interface of the ambient air and the wall of the container is therefore preferably not 90°.

According to a further preferred embodiment, the at least one detection device comprises a first detector which detects the emitted radiation in the first state. Accordingly, the first detector is positioned relative to the container such that the radiation emerging from the container strikes the detector. In the second state, the emitted radiation is no longer detected by the first detector or is detected to a lesser extent due to a change in the angle of refraction. In the second state, the refraction angle changes due to the change in the medium in the beam path of the emitted radiation inside the container. The radiation emerging from the container is thus moved away from the first detector so that it no longer detects the radiation or detects it to a lesser extent.

Such a change can advantageously result in a binary output signal. This means that the output values “Radiation present” or “Radiation not present” are output. However, it is also conceivable that the first detector detects radiation with a lower intensity in the second state. This can be the case, for example, with a radiation source device with diverging radiation. Due to the spatial width of the beam, the first detector still detects part of the radiation, albeit a smaller part, even after the refraction angle has been changed. Based on these output values, conclusions can be drawn as to whether the level has fallen below a minimum level or exceeded a maximum level. It is also advantageous to be able to draw conclusions about the medium or liquid in the container based on the output value.

According to a further preferred embodiment, the at least one detection device comprises a second detector, which detects the emitted radiation in the second state. The second detector is spatially spaced from the first detector. Accordingly, in an advantageous first state, the emitted radiation predominantly or entirely strikes the first detector. The change in the medium changes at least one angle of refraction, as a result of which the radiation is moved from the first detector to the second detector. The second detector then detects most or all of the emitted radiation. The first detector preferably continues to detect a first radiation intensity. Preferably, the second detector continues to detect a second radiation intensity in the second state. Advantageously, the second radiation intensity is greater or less than the first radiation intensity. An evaluation of the detected radiation intensities can provide further information in addition to the binary information of the output values with regard to the fill level.

According to a further preferred embodiment, the first detector and the second detector are part of a detector array. Advantageously, the detector array comprises at least two detectors.

According to a further preferred embodiment, the at least one radiation source device and the at least one detector device are arranged on a carrier device. Preferably, the radiation inside the container is deflected in such a way that the radiation emerging from the container reaches the at least one detector device on the carrier device. Preferably, the geometry and/or the material of the container is such that the radiation is deflected in such a way that the radiation emerging from the container reaches the at least one detector device on the carrier device.

Advantageously, the geometry and/or the material of the container is designed in such a way that the radiation undergoes at least total reflection at the interface with an inner surface of a wall of the container. Such a design allows a compact device to be provided which comprises both the at least one radiation source device and the at least one detector device.

According to another preferred embodiment, a liquid edge area is formed at the interface between the liquid and the container due to the surface tension of the liquid surface. This is due to adhesion at the interface between the liquid and the container. Preferably, the liquid edge area has a characteristic curvature and a corresponding characteristic refractive power. Accordingly, the emitted radiation can pass through the liquid edge area in a third state. Advantageously, in the third state, the beam path of the emitted radiation is above the fill level, but so close to the fill level that the liquid edge area is penetrated by the radiation. Preferably, a characteristic change in the radiation properties can be detected when the radiation passes through the liquid edge area. Advantageously, the liquid edge area is characteristic for each combination of a particular liquid with a particular container. If the container remains unchanged, the liquid in the container can thus be identified.

According to a further preferred embodiment, the at least one radiation source device is a laser, an LED or a similar radiation source. The beams incident on the container may be divergent. Preferably, the beams incident on the container have a cross-sectional profile. This cross-sectional profile can be point-shaped, linear or otherwise. Advantageously, the emitted radiation of the at least one radiation source has a wavelength in the range 200 nm to 10000 nm. It is also conceivable that the emitted radiation of the at least one radiation source has a wavelength in the visible range (380 nm to 780 nm).

According to a further preferred embodiment, the emitted radiation is guided to the container by means of at least one optical component. The optical component is selected from: an optical waveguide, a mirror, a lens, a prism, an optical grating, a beam splitter. Of course, several of the aforementioned optical components can be used in combination. In an analogous manner, such at least one optical component can be provided to guide the radiation emerging from the container 3 to the at least one detection device.

According to a further preferred embodiment, at least one radiation source device emits radiation with a predetermined spectrum. Preferably, this spectrum has a predetermined wavelength range. For example, the spectrum may comprise visible white light. It is also conceivable that radiation with varying wavelengths is emitted by the at least one radiation source device within a predetermined time interval. The radiation can preferably be varied from an initial wavelength to a final wavelength. Preferably, the radiation is continuously increased or decreased. A variation of discrete wavelengths would also be conceivable. Advantageously, the change in radiation properties of the emitted radiation is evaluated as a function of the wavelength. For example, the complex-value refractive index n̅ (λ), which is dependent on the wavelength, is preferably analysed. Accordingly, the real refractive index and/or the absorption can be evaluated as a function of the wavelength of the emitted radiation.

The present problem is also solved by a system for detecting a liquid level for a household appliance comprising a container for holding the liquid, wherein at least one radiation source device and at least one detection device are provided, wherein in a first state the emitted radiation of the at least one radiation source device has a fixed beam path through the container, wherein radiation properties of a second radiation emitted by the liquid can be detected by means of the at least one detection device, wherein the container consists at least partially of a material which is at least partially transparent to the emitted radiation of the at least one radiation source device, wherein radiation properties of a second radiation emitted by the liquid can be detected by means of the at least one detection device, wherein the container consists at least partially of a material which is at least partially transparent for the emitted radiation of the at least one radiation source device and the second radiation emitted by the liquid.

This system can be equipped with all the features already described above in the context of the first system, either individually or in combination with each other, and vice versa.

It is also conceivable that the at least one detection device detects radiation properties of a second radiation emitted by the liquid and that a change in the radiation properties of the emitted radiation can also be detected. The change is preferably due to the passage through the container. This corresponds to an advantageous combination of the first system described above and the second system, which detects a second radiation emitted by the liquid.

Preferably, the second radiation is emitted from the liquid by incidence of the first radiation into the liquid. Preferably, the second radiation is fluorescent radiation, which is emitted due to excitation by the at least one radiation source device. It is also conceivable that the second radiation is phosphorescent radiation.

Preferably, a minimum or maximum level is detected by the presence of a second radiation and/or by a change in the detected intensity of the second radiation.

Preferably, the Stokes shift is analysed to determine a minimum or maximum level. This is a shift in the wavelength between the radiation absorbed by the liquid from the at least one radiation source device and the second radiation emitted by the liquid.

Preferably, the isotropy of the second radiation emitted by the liquid is analysed to determine a minimum or maximum level. A change in the liquid level preferably leads to a change in a characteristic spatial distribution of the second radiation emitted by the liquid. This characteristic spatial distribution is detected by the at least one detection device. The at least one detection device advantageously comprises a plurality of detectors, preferably a detector array.

Advantageously, the at least one detection device comprises an optical filter, preferably a band-pass filter and/or a long-pass filter and/or a short-pass filter.

Preferably, when evaluating the second radiation, it is not necessary for at least one interface to have a non-perpendicular incidence of the radiation emitted by the at least one radiation source device.

The present task is also solved by a method for detecting a liquid level with a system for detecting a liquid level according to one of the above embodiments. The method can be equipped with all the features already described above in the context of the system, either individually or in combination with one another, and vice versa.

The present task is also solved by a dosing device for a household appliance, in particular for a water-carrying household appliance, with a system for detecting a liquid level according to one of the above embodiments. The dosing device can be equipped with all the features already described above in the context of the system, either individually or in combination with one another, and vice versa.

Advantageously, the dosing device comprises the container for holding the liquid. If it detects that the level has fallen below the minimum level, the dosing device can send and/or output a notification signal to a user. Alternatively or cumulatively, the dosing device can automatically refill the container with liquid.

The present task is also solved by a household appliance with a system for detecting a liquid level according to one of the above embodiments. The household appliance can be equipped with all the features already described above in the context of the system, either individually or in combination with one another, and vice versa.

Preferably, the household appliance is a refrigerator, a water-bearing household appliance, for example a washing machine or a dishwasher or another household appliance.

According to a preferred embodiment, the household appliance comprises at least one vibration unit. Preferably, such a vibration unit may be a dosing device, a pump device, a motor or the like. Preferably, vibrations are transmitted to the housing of the household appliance by means of the vibration unit. Preferably, a control device is provided which evaluates an output signal from the at least one detection device. The control device can also output a corresponding notification signal or initiate automatic filling.

Preferably, the household appliance comprises a dosing device and a pump device.

During operation of the at least one vibration unit, for example the pumping device, vibrations are transmitted through the housing of the household appliance to the container and to the liquid in the container. The output signal of the at least one detection device is larger during operation, for example during the pumping process, due to the vibrations. This is due to reflections on the surface of the liquid. Preferably, the control device evaluates an output signal from the at least one detection device within a predetermined time interval. It is advantageous for the control device to evaluate the shape of the output signal over time. Preferably, the derivative of the output signal is analysed according to time. Here, dS/dt=0 corresponds to dS/dV=0, where V corresponds to the volume of the liquid and S corresponds to the magnitude of the output signal.

According to a preferred embodiment, a noise component occurs in the analysed signal due to the operation of the at least one vibration unit, for example the pump device. The noise component occurs due to the transmission of the vibrations of the at least one vibration unit, for example the pump device, to the container and the liquid located in the container. Preferably, the noise component is used to analyse a fill level. If the liquid surface is located in the beam path of the emitted radiation, the noise component is maximised. If the beam path is in the liquid or above the liquid, i.e. within the gas mixture or the air, the noise component is small. An evaluation of the noise component can therefore preferably indicate the transition between the first state and the second state.

Further advantages, objectives and features of the present invention are explained with reference to the following description of the attached figures. Similar components may have the same reference signs in the various embodiments.

### BRIEF DESCRIPTION OF THE DRAWINGS

It shows:

FIG. 1 a system for detecting a fill level according to one embodiment;

FIG. 2 a system for detecting a fill level according to one embodiment;

FIG. 3 a system for detecting a fill level according to one embodiment;

FIG. 4 a system for detecting a fill level according to one embodiment;

FIG. 5 a geometry of a container;

FIG. 6 a geometry of a container;

FIG. 7 a system for detecting a fill level according to one embodiment;

FIG. 8 a household appliance;

FIG. 9A schematic diagram of a household appliance; and

FIG. 10 a system for detecting a fill level according to one embodiment.

### DETAILED DESCRIPTION

FIGS. 1 to 4 and 7 show a system for detecting a liquid level 2 for a household appliance 100 comprising a container 3 for holding the liquid. Thereby at least one radiation source device 4 and at least one detection device 5 are provided, wherein the container 3 consists at least partially of a material which is at least partially transparent for the emitted radiation 6 of the at least one radiation source device 4, wherein, in a first state, the emitted radiation 6 of the at least one radiation source device 4 has at least one fixed beam path 7 through the container 3, wherein a change in radiation properties of the emitted radiation 6 can be detected by means of the at least one detection device 5. The change is due to the passage of the radiation (6) through the container.

The container 3 has an extension along a height axis Z, a width axis X and a longitudinal axis Y. Furthermore, the container 3 comprises a conversion 3a, which at least partially encloses an interior. This interior space is filled with a first medium 8 (liquid or air) and a second medium 9 (air or liquid). The liquid level 2 of the liquid can be defined as a height along the height axis Z on which the liquid surface 14 is located. A minimum level 2a is a predetermined fill level 2. When this minimum level 2a is reached and/or undershot, a predetermined action is to be carried out. A maximum level 2b is another predetermined level 2. When this maximum level 2b is reached and/or exceeded, a predetermined action should also be carried out. These predefined actions can be, for example, sending or displaying a message to a user or automatic filling or emptying.

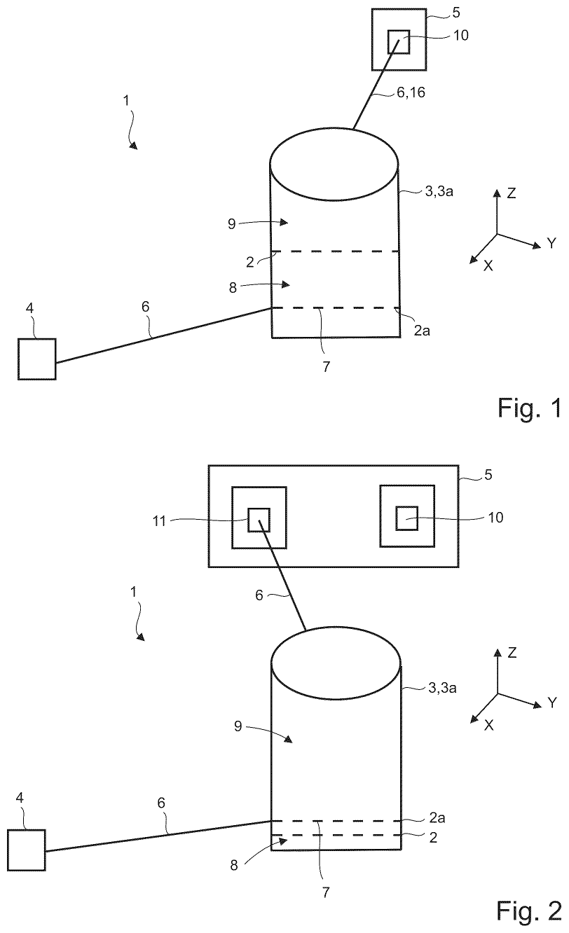

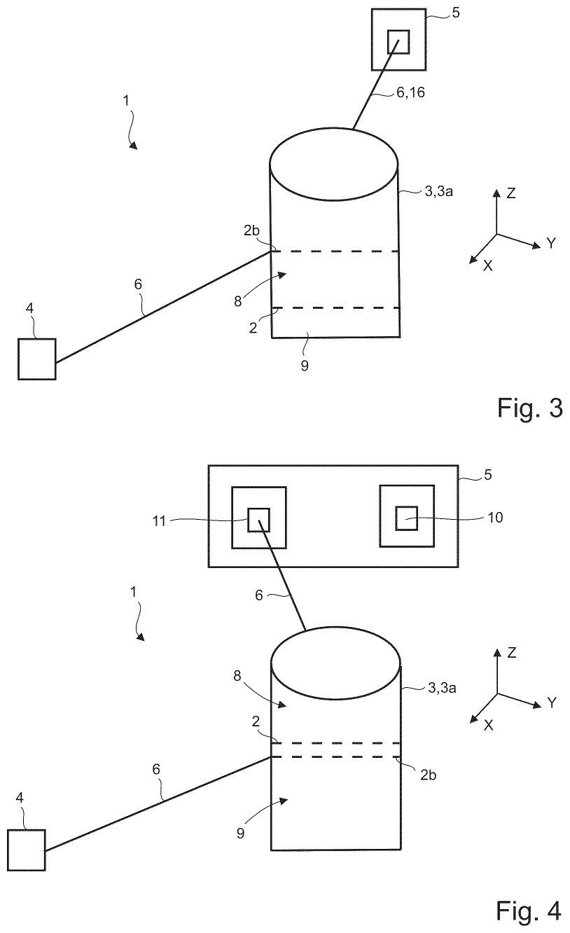

FIGS. 1 and 2 show embodiments by means of which a level 2b falling below a minimum level can be detected. FIGS. 3 and 4 show embodiments by means of which an overshoot of a maximum level 2b can be detected.

FIG. 1 shows a system 1 in a first state. The emitted radiation 6 passes through a first medium 8 in the container 3, which in this case is a liquid. The emitted radiation 6 of the at least one radiation source device 4 impinges on the container at the height of a predetermined minimum level 2a or below this minimum level 2a. However, the actual fill level 2 is above the minimum level 2a along the height axis Z. The radiation 6 thus passes through the first medium in the form of liquid. In this case, the at least one detection device 5 comprises only a first detector 10 and is arranged in such a way that the radiation exiting the container strikes the first detector 10.

FIG. 2 shows a second state of the system 1. The actual fill level 2 is now below the minimum level 2a and thus below the beam path of the emitted radiation 6. The emitted radiation 6 now passes through the second medium in the form of air (can also be any other type of gas mixture). During the transition from the first state to the second state, the radiation entering the container 3 remains the same. Within the container 3, however, the radiation 6 now passes through the second medium 9 (air) instead of the first medium 8 (liquid). The change in the medium 8, 9 changes at least one angle of refraction of the radiation 6. The beam is thus deflected and now no longer hits the first detector 10 as it exits the container 3.

According to one embodiment, only a first detector 10 can be provided. Since radiation is no longer detected by this first detector 10 when the medium changes, this fact can be interpreted as falling below the minimum level 2a.

According to a further embodiment as shown in FIG. 2, a second detector 11 is present, which is also part of the at least one detection device 5. The second detector 11 is positioned in such a way that the radiation 6 passing through the second medium 9 (air) now strikes this second detector with at least a changed angle of refraction. Thus, in addition to the absence of a signal from the first detector 10, the occurrence of a signal from the second detector 11 can be interpreted as falling below the minimum level 2a. The occurrence of the signal from the second detector 11 thus serves as a check or confirmation of the interpretation of the first detector 10. Furthermore, both the first detector 10 and the second detector 11 can determine an intensity of the incident radiation 6. Since the first medium 8 (liquid) and the second medium 9 (air) have different absorption behaviour, the detected intensities in the first state and in the second state will differ. This is a further indicator for falling below a minimum level 2a. It is therefore possible to detect when a minimum level 2a is reached and/or not reached.

FIG. 3 shows a system 1 in a first state. The emitted radiation passes through a first medium 8 in the container 3, which is now air (can also be any other type of gas mixture). The emitted radiation 6 from the at least one radiation source 4 strikes the container at the level of a maximum level 2b or above the maximum level 2b. The actual fill level 2 is below the maximum level 2b, so that the radiation 6 passes through the first medium in the form of air. In this case too, the detection device 5 comprises only a first detector 10 and is arranged in such a way that the radiation 6 emerging from the container strikes the first detector 10.

FIG. 4 shows a second state of the system 1. The actual fill level 2 is now above the maximum level 2a and therefore above the beam path of the emitted radiation 6. The emitted radiation 6 now passes through the second medium in the form of liquid. During the transition from the first state to the second state, the radiation entering the container 3 remains the same. Within the container 3, however, the radiation 6 now passes through the second medium 9 (liquid) instead of the first medium 8 (air). The change in the medium 8, 9 changes at least one angle of refraction of the radiation 6. The beam is thus deflected and now no longer hits the first detector 10 as it exits the container 3.

According to one embodiment, only a first detector 10 can be provided. Since radiation is no longer detected by this first detector 10 when the medium changes, this fact can be interpreted as the maximum level 2b being exceeded.

According to a further embodiment as shown in FIG. 4, a second detector 11 is present, which is also part of the at least one detection device 5. The second detector 11 is positioned in such a way that the radiation 6 passing through the second medium 9 (liquid) now strikes this second detector 11 with at least a changed angle of refraction. Thus, in addition to the absence of a signal from the first detector 10, the occurrence of a signal from the second detector 11 can be interpreted as exceeding the maximum level 2b. The occurrence of the signal from the second detector 11 thus serves as a check or confirmation of the interpretation of the first detector 10. Furthermore, both the first detector 10 and the second detector 11 can determine an intensity of the incident radiation 6. Since the first medium 8 (air) and the second medium 9 (liquid) have different absorption behaviour, the detected intensities in the first state and in the second state will differ. This is another indicator that a maximum level 2b has been exceeded. Reaching and/or exceeding a maximum level 2b can thus be detected.

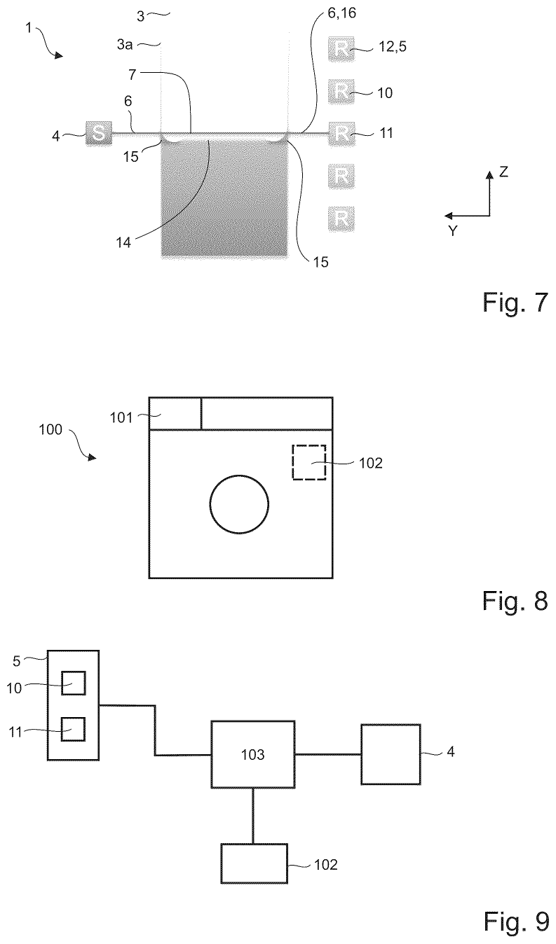

The first detector 10 and the second detector 11 may be a phototransistor, a photodiode, a photoresistor, a photomultiplier or the like. Further, the first detector 10 and the second detector 11 may be part of a detector array 12 as shown, for example, in FIG. 7. The at least one radiation source device 4 may be a laser an LED or the like. Preferably, the at least one radiation source device 4 emits radiation in the visible wavelength range (380 nm to 780 nm). The emitted radiation 6 can be guided to the container 3 by means of at least one optical component, for example an optical waveguide, a mirror, a lens, a prism, an optical grating or a beam splitter. In an analogous manner, such at least one optical component can be provided in order to guide the radiation 6 emitted from the container 3 to the at least one detection device 5.

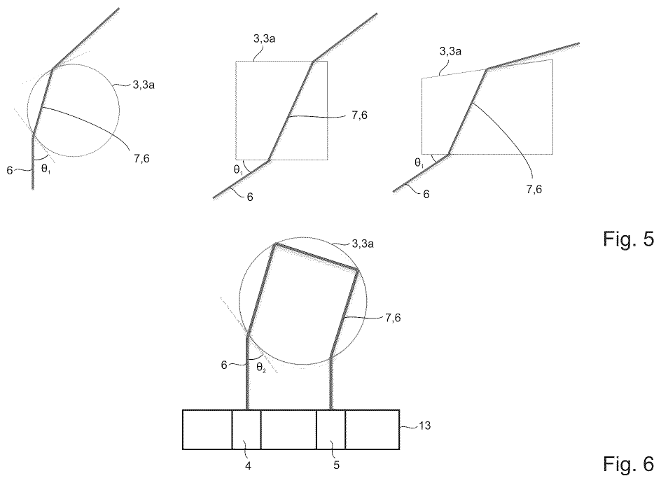

The container 3 can be designed as a hollow cylindrical element with an interior. The basic shape of this hollow cylindrical element can be of any design. The geometric shape of the container 3 results in different refraction at the respective interfaces. The angle of incidence θ₁ should not be perpendicular to the wall 3a of the container 3. FIG. 5 shows some examples of possible shapes of the container 3 and a corresponding beam path of the radiation 6 through this container 3. The arrangement of the at least one detection device 5 can be adapted to the shape of the container 3 or to the emerging beam 6.

According to the embodiment shown in FIG. 6, the geometric shape and/or the material of the container 3 is designed such that the radiation is deflected within the interior of the container 3 such that the radiation 6 emerging from the container 3 is essentially directed in the opposite direction to the radiation incident on the container. In such a configuration, the at least one radiation source device 4 and the at least one detector device 5 can be arranged on a single carrier device 13. Such a carrier device 13 can, for example, be a printed circuit board (PCB).

FIG. 7 shows a further embodiment example, by means of which a so-called surface tension spectroscopy can also be carried out. Due to the surface tension and the adhesion of the liquid, a liquid edge area 15 forms at the interface between the liquid and the container 3. This liquid edge area 13 extends along the height axis Z above the liquid surface 14 and has a characteristic curvature and correspondingly characteristic refractive properties. The capillary effect influences the radiation 6 passing through the liquid edge area 13 due to the refractive properties and the characteristic curvature of this liquid edge area 13. If the liquid level 2 of the liquid drops downwards along the height axis Z, the radiation 6 passes through the liquid edge area at a certain point in time, as shown in FIG. 7, and a corresponding optical signal is output by the at least one detection device 5 with respect to the liquid edge area 13. Since the properties of the container 3 are known, this signal can be used to draw conclusions about the liquid. This method can also be carried out with a vertical incidence of the radiation 6 on the container 3, as shown in FIG. 7.

The system 1 for detecting a fill level 2 can be part of a dosing device 101 for a household appliance 100, in particular for a water-carrying household appliance 100. Such a water-carrying household appliance 100 can be, for example, a washing machine as shown in FIG. 8. Treatment agents, for example detergent or fabric softener, can be supplied to the wet room by means of dosing device 101.

The household appliance 100 can further comprise at least one vibration unit 102, which can transmit vibrations to the housing of the household appliance. This can be a pump device, a motor or the like.

The household appliance 100 further comprises a control device 103. The control device 103 evaluates an output signal of the at least one detection device 5 and is thus connected to it in terms of signalling technology, as shown in FIG. 9.

By operating the at least one vibration unit 102, for example the pump device 102, vibrations are transmitted via the housing of the household appliance 100 to the container or the liquid in the container. These vibrations can be used to evaluate the level 2 of the liquid. The control device 103 evaluates an output signal of the at least one detection device 5 within a predetermined time interval. In particular, the shape of the time course of the output signal is evaluated by the control device 103. During operation, for example during the pumping process, the signal of the at least one detection device 5 has a higher magnitude. The reason for this is the detection of reflections on the liquid surface. The control device 103 evaluates the derivative of the output signal according to time. Here, dS/dt=0 corresponds to dS/dV=0, where V corresponds to the volume of the liquid. As a condition for this, the output signal should be defined in such a way that there is no output signal at a fill level 2 above the minimum level 2a and an output signal with a large magnitude at a fill level 2 below the minimum level 2a.

According to one embodiment, a noise component occurs in the analysed signal due to the operation of the at least one vibration unit 102, for example the pump device, or due to the transmitted vibrations. This noise component can be used to detect a fill level. If the liquid surface is located in the beam path of the emitted radiation, the noise component in the output signal is maximised. If the beam path is in the liquid or above the liquid, i.e. within the gas mixture or the air, the noise component is small. An evaluation of the noise component can therefore preferably indicate the transition between the first state and the second state.

A combination of these methods would also be conceivable.

According to a further embodiment, the at least one radiation source device 4 emits radiation 6 with a predetermined spectrum having a predetermined wavelength range. For example, the spectrum may comprise visible white light.

Similarly, the at least one radiation source device 4 could emit radiation 6 with varying wavelengths within a predetermined time interval. The emitted radiation 6 can be varied continuously or with respect to discrete values. The output signal is then evaluated by the control device 103 as a function of the wavelength of the emitted radiation 6.

As an alternative to detecting a change in radiation properties of the emitted radiation 6 by means of the at least one detection device 5, the system 1 can detect radiation properties of a second radiation 16 emitted by the liquid. Such a second radiation 16 is fluorescent radiation of the liquid due to an excitation by the radiation 6 incident on the liquid from the at least one radiation source device 4. A falling below a minimum level or an exceeding of a maximum level as well as a determination of the liquid can thus be made by an evaluation of the detected second radiation 16.

However, the system 1 can also detect both a change in radiation properties of the emitted radiation 6 by means of the at least one detection device 5 and also detect radiation properties of a second radiation 16 emitted by the liquid. Such a second radiation 16 is fluorescent radiation of the liquid due to an excitation by the radiation 6 incident on the liquid from the at least one radiation source device 4. A level falling below a minimum level or exceeding a maximum level and a determination of the liquid can thus be made by evaluating the radiation of the at least one radiation source device 4 and the second radiation 16 that has passed through the container and the medium in the container.

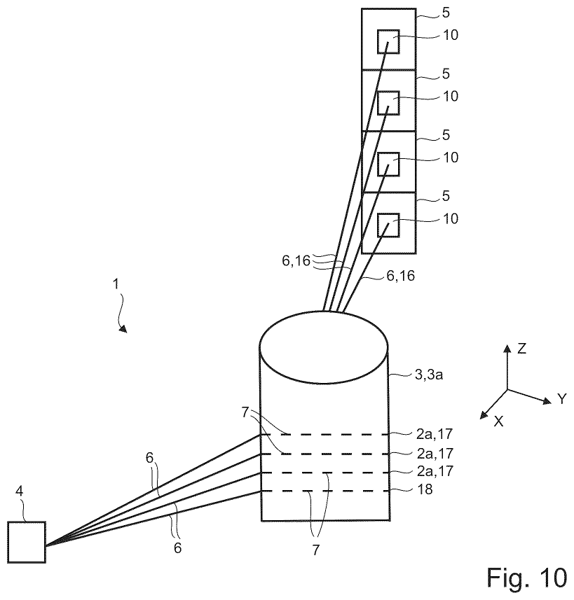

FIG. 10 shows a further embodiment. In a first state, the emitted radiation of the at least one radiation source device has several defined beam paths 7 through the container 3. The system thus comprises several detection planes 17, with each detection plane 17 being assigned a beam path 7. Furthermore, a minimum level 2a or a maximum level 2b is assigned to each detection plane 17. The detection planes 17 are arranged one above the other along the height axis Z of the container 3. The minimum level 2a or the maximum level 2b can thus be detected in each detection plane 17. From this, different fill levels can be output with knowledge of the height of the respective detection plane 17. Preferably, a reference plane 18 is provided in which the beam path 7 is always located in the first or second medium. In FIG. 10, the beam path 7 is always in the liquid. The detection of this beam path 7 can thus be used as a reference, for example to compensate for temperature fluctuations.

Applicant reserves the right to claim all features disclosed in the application documents as being essential to the invention, provided that they are new, either individually or in combination, compared with the prior art. It should also be noted that the individual figures also describe features which may be advantageous in themselves. The skilled person immediately recognises that a particular feature described in a figure can also be advantageous without the adoption of further features from this figure. Furthermore, the skilled person recognises that advantages can also result from a combination of several features shown in individual figures or in different figures.

### LIST OF REFERENCE SYMBOLS

1 System
2 Liquid level of a liquid
2a Minimum level
2b Maximum level
3 Container
3a Conversion
4 Radiation source device
5 Detection device
6 Emitted radiation
7 Beam path
8 first medium
9 Second medium
10 first detector
11 Second detector
12 Detector array
13 Carrier device
14 Liquid surface
15 Liquid edge area
16 Second radiation
17 Detection plane
18 Reference plane
100 Household appliance
101 Dosie cleaning equipment
102 Vibration unit
103 Control device
_{Θ(1)} Angle of incidence

1. System (1) for detecting a liquid level (2) for a household appliance (100) comprising a container (3) for holding the liquid, wherein
at least one radiation source device (4) and at least one detection device (5) are provided, wherein the container (3) consists at least partially of a material which is at least partially transparent for the emitted radiation (6) of the at least one radiation source device (4), wherein, in a first state, the emitted radiation (6) of the at least one radiation source device (4) has at least one fixed beam path (7) through the container (3), wherein a change in radiation properties of the emitted radiation (6) can be detected by means of the at least one detection device (5).

2. System (1) according to claim 1, wherein
in a first state the emitted radiation (6) passes through a first medium (8) in the container (3), wherein in a second state the emitted radiation (6) passes through a second medium (9) in the container, wherein at a transition from the first state to the second state at least a partial quantity of the first medium (8) is removed from the container (3) and replaced by the second medium (9), wherein a change in the liquid level (2) in the container (3) takes place during a transition from the first state to the second state, wherein the first medium (8) is the liquid or a gas mixture, wherein the second medium (9) is a gas mixture or the liquid.

3. System (1) according to claim 2, wherein
the change in the radiation properties is due to a difference in the optical properties between the first medium (8) and the second medium (9), at least one refraction angle and/or the radiation intensity of the emitted radiation (6) changing during a transition from the first state to the second state.

4. System (1) according to claim 2, wherein
the emitted radiation passes through at least one interface between two media.

5. System (1) according to claim 2, wherein
the at least one detection device (5) comprises a first detector (10) which detects the emitted radiation (6) in the first state, wherein in the second state the emitted radiation (6) is not detected by the first detector (10) due to a change in the angle of refraction.

6. System (1) according to claim 5, wherein
the at least one detection device (5) comprises a second detector (11) which detects the emitted radiation (6) in the second state, wherein the second detector (11) is spatially spaced from the first detector (10), wherein the first detector (10) and the second detector (11) are part of a detector array (12).

7. System (1) according to claim 1, wherein
the at least one radiation source device (4) and the at least one detector device (5) are arranged on a carrier device (13), wherein the radiation (6) inside the container (3) is converted in such a way that the radiation (6) emerging from the container (6) reaches the at least one detector device (5) on the carrier device (13).

8. System (1) according claim 1, wherein
a liquid edge area (15) is formed at the interface between the liquid and the container (3) due to the surface tension of the liquid surface (14), wherein the liquid edge area (15) has a characteristic curvature, wherein in a third state the emitted radiation (6) passes through the liquid edge area (15), wherein a characteristic change in the radiation properties can be detected when passing through the liquid edge area (15).

9. System (1) according claim 1, wherein
the emitted radiation (6) is guided to the container (3) by means of at least one optical component, wherein the optical component is selected from: an optical waveguide, a mirror, a lens, a prism, an optical grating, and a beam splitter.

10. System (1) according to claim 1,
at least one radiation source device (4) emits radiation (6) with a predetermined spectrum or emits radiation (6) with a varying wavelength within a predetermined time interval, wherein the change in radiation properties of the emitted radiation (6) is evaluated as a function of the wavelength.

11. A system (1) for detecting a liquid level (2) for a household appliance (100) comprising a container (3) for holding the liquid, wherein
at least one radiation source device (4) and at least one detection device (5) are provided, wherein in a first state the emitted radiation (6) of the at least one radiation source device (4) has a fixed beam path (7) through the container (3), wherein radiation properties of a second radiation (16) emitted by the liquid can be detected by means of the at least one detection device (5), wherein the container (3) consists at least partially of a material which is at least partially transparent for the emitted radiation (6) of the at least one radiation source device (4) and the second radiation (16) emitted by the liquid.

12. Dosing device (101) for a household appliance (100), in particular for a water-carrying household appliance (100), with a system (1) for detecting a liquid level (2) according to claim 11.

13. Household appliance (100) with a system (1) for detecting a liquid level (2) according to claim 11 comprising at least one vibration unit (102), wherein a control device (103) is provided which evaluates an output signal of the at least one detection device (5).

14. The household appliance (100) according to claim 10, wherein
the control device (103) evaluates an output signal of the at least one detection device (5) within a predetermined time interval, wherein the control device (103) evaluates the shape of the time course of the output signal.

15. The household appliance (100) according to claim 10, wherein
a noise component occurs in the evaluated signal as a result of the operation of the vibration unit (102), the noise component being used to evaluate a fill level (2).

16. System (1) according to claim 2, wherein the emitted radiation passes through a plurality of interfaces.

17. System (1) according to claim 4, wherein the emitted radiation is not incident perpendicular to the at least one interface.

18. Dosing device (101) for a household appliance (100), in particular for a water-carrying household appliance (100), with a system (1) for detecting a liquid level (2) according to claim 1.

19. Household appliance (100) with a system (1) for detecting a liquid level (2) according to claim 1 comprising at least one vibration unit (102), wherein a control device (103) is provided which evaluates an output signal of the at least one detection device (5).
